(19) United States
(12) Patent Application Publication
(10) Pub. No.: US 2021/0337798 A1
(43) Pub. Date: Nov. 4, 2021

(54) ANTIMICROBIAL COMPOSITIONS COMPRISING WOLLASTONITE

(71) Applicant: IMERTECH SAS, Paris (FR)

(72) Inventors: Jörg SCHMITZ, Köln (DE); Lieven VERSTUYFT, Oosterzele (BE); Jerome BOLLARD, Asnieres (FR)

(21) Appl. No.: 17/282,408

(22) PCT Filed: Oct. 4, 2019
(86) PCT No.: PCT/EP2019/076875

§ 371 Date: Apr. 2, 2021

(30) Foreign Application Priority Data
Oct. 5, 2018 (EP) 18306321.3

(51) Int. Cl. A01N 43/80; C09D 7/63; C09D 7/61; C09D 7/40; C08K 3/34; C09D 123/08

(52) U.S. Cl. CPC A01N 43/80; C09D 7/63; C09D 7/61; C08K 2003/265; C08K 3/34; C09D 123/0853; C09D 7/66

(57) ABSTRACT

The present invention relates to an antimicrobial composition comprising wollastonite as the antimicrobial agent booster and uses thereof. The present invention also relates to a paint or a coating composition comprising the antimicrobial composition and an article treated with the antimicrobial composition according to the invention.

### FIELD OF THE INVENTION

The present invention is directed to an antimicrobial composition comprising wollastonite as the antimicrobial agent booster and uses thereof. The present invention is also directed to a paint or a coating composition comprising the antimicrobial composition of the invention and an article treated with the antimicrobial composition according to the invention.

### BACKGROUND OF THE INVENTION

Microbial growth in paint, coatings and on surfaces can lead to both aesthetic and physical degradation of the coating or painted surface. In addition to the obvious aesthetic effects of fungal, such as mould and mildew, algae and bacterial growth, physical deterioration by their enzymes can lead to physical degradation. This degradation can include an increase in porosity of the surface coating or a loss of adhesion to the substrate. For example, moisture penetration of the paint, coating or varnish exterior on wood can lead to fungal decay of the underlying wood. Biodegradation is not limited to the surface coating or dry paint films, it can also occur during production and storage of the paint or coating.

There are a number of challenges when selecting antimicrobial agents for use in antimicrobial composition. One of the challenges is that there are currently relatively few biocides, fungicides and algaecides available. Such actives are required to fulfil a range of requirements. In addition to covering a large microbial spectrum there is also the regulatory status of the active agents to be considered. It is therefore desirable to reduce the amount of antimicrobial agents in the antimicrobial compositions, for use in, for example, paints and coatings.

### SUMMARY OF THE INVENTION

The present invention is defined in the appended claims.

In accordance with a first aspect, there is provided an antimicrobial composition comprising wollastonite as the antimicrobial agent booster.

In accordance with a second aspect, there is provided a paint or coating composition comprising an antimicrobial composition according the first aspect.

In accordance with a third aspect, there is provided a use of the antimicrobial composition according to the first aspect to prevent microbial growth in a liquid and/or on an object.

In accordance with the fourth aspect there is provided a method of preventing microbial growth in a liquid and/or on an object by applying the composition of the first aspect to a liquid and/or an object.

In accordance with a fifth aspect there is provided an article treated with an antimicrobial composition of the first aspect.

Certain embodiments of the present invention may provide one or more of the following advantages:
desired antibacterial effect;
desired antifungal effect;
desired antialgae effect;
desired environmental impact;
desired effect on skin sensitivity;
desired cost;
desired aesthetic properties of paint, such as opacity;
desired aesthetic properties of paint, such as gloss
desired aesthetic properties of paint, such as brightness
desired physical properties of coating, such as hardness.
desired physical properties of coating, such as scrub resistance
desired physical properties of coating, such as anti-cracking

The details, examples and preferences provided in relation to any particular one or more of the stated aspects of the present invention apply equally to all aspects of the present invention. Any combination of the embodiments, examples and preferences described herein in all possible variations thereof is encompassed by the present invention unless otherwise indicated herein, or otherwise clearly contradicted by context.

### BRIEF DESCRIPTION OF THE DRAWINGS

The invention will further be illustrated by reference to the following figures:

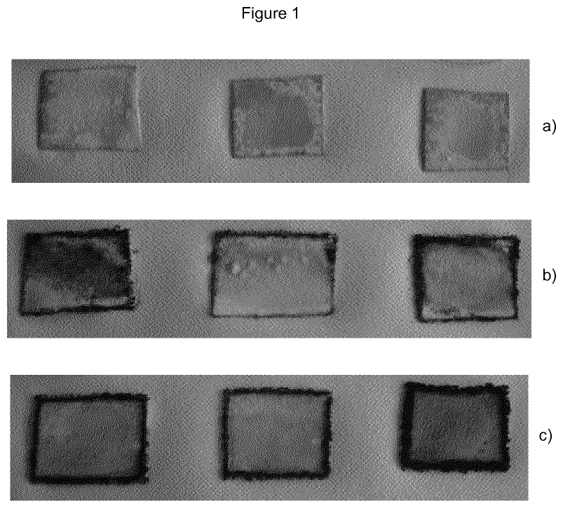

FIG. 1 demonstrates the antifungal properties of the compositions according to the invention and depicts the results shown in Table 10 for:
a) formulation 9;
b) formulation 10; and
c) formulation 11.

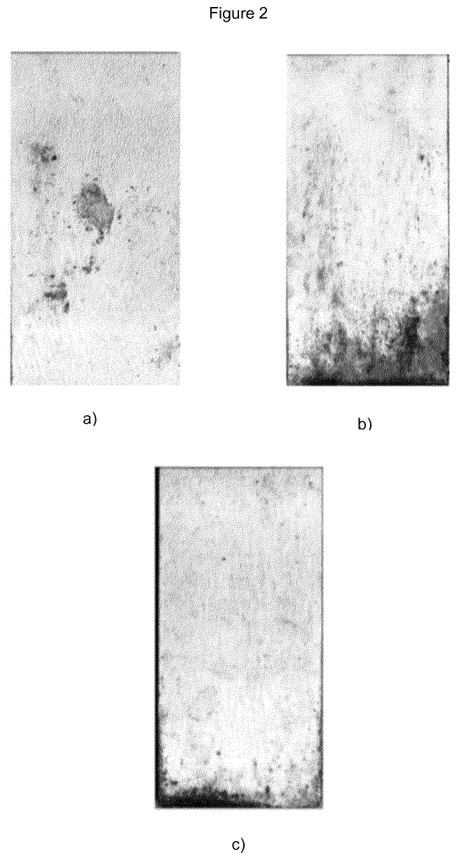

FIG. 2 demonstrates the antialgae properties of the compositions according to the invention and depicts the results shown in Table 11 for:
a) formulation 9;
b) formulation 10; and
c) formulation 11.

It is understood that the following description and references to the figures concern exemplary embodiments of the present invention and shall not be limiting the scope of the claims.

### DETAILED DESCRIPTION

The present invention is based on the surprising finding that wollastonite exhibits a booster effect on the antimicrobial activity of antimicrobial agents. Wollastonite is an industrial mineral comprised chemically of calcium, silicon and oxygen. Its molecular formula is CaSiO₃ and its theoretical composition consists of 48.28% CaO and 51.72% SiO₂. Natural wollastonite may contain trace or minor amounts of various metal ions such as aluminum, iron, magnesium, potassium and sodium.

In certain embodiments the wollastonite is untreated, meaning that the wollastonite is not coated or bound with any material or chemical before being used in the composition. In certain embodiments, the wollastonite is mined and ground and used directly in the compositions of the present invention. In certain embodiments, after benefication, wollastonite was processed through an air classifying mill then pebble milled or jet milled, whilst controlling the top size.

The wollastonite disclosed herein has a particle size. Particle size may be measured by any appropriate measurement technique now known to the skilled artisan or hereafter discovered. Unless otherwise stated, particle size and particle size properties, such as particle size distribution (“psd”), are measured using a Leeds and Northrup Microtrac X100 laser particle size analyzer (Leeds and Northrup, North Wales, Pa., USA), which can determine particle size distribution over a particle size range from 0.12 μm to 704 μm. The size of a given particle is expressed in terms of the diameter of a sphere of equivalent diameter that sediments through the suspension, also known as an equivalent spherical diameter or “esd.” The median particle size, or d₅₀ value, is the value at which 50% by weight of the particles have an esd less than that d₅₀ value. The d₁₀ value is the value at which 10% by weight of the particles have an esd less than that d₁₀ value. The d₉₀ value is the value at which 90% by weight of the particles have an esd less than that d₉₀ value.

In certain embodiments wollastonite has a mean particle size d₅₀ of about 5 to about 120 microns, or about 6 to about 100 microns, or about 7 to about 80 microns, or about 9 to about 60 microns, or about 10 to about 40 microns, or about 11 to about 20 microns, or about 12 to about 18 microns, or about 13 to about 16 microns.

The surface area of the mineral is measured using the BET method by quantity of nitrogen adsorbed on the surface of said particles so as to form a monomolecular layer completely covering said surface (measurement according to the BET method, AFNOR standard X11-621 and 622 or ISO 9277).

In certain embodiments, the BET surface area is in the range of about 0.2 to about 5.0 m²/g, or about 0.4 to about 4.8 m²/g, or about 0.6 to about 4.6 m²/g, or about 0.8 to about 4.4 m²/g, or about 0.6 to about 4.2 m²/g, or about 1.0 to about 4.0 m²/g, or about 1.2 to about 3.8 m²/g, or about 1.4 to about 3.6 m²/g, or about 1.6 to about 3.0 m²/g, or about 1.7 to about 2.7 m²/g, or about 1.8 to about 2.5 m²/g, or about 1.9 to about 2.2 m²/g.

The morphology of the wollastonite, according to some embodiments, may be characterized by aspect ratio. The aspect ratio of a particulate refers generally to a ratio of the length-to-width of the particulate. For a given particulate sample, the aspect ratio may be determined as an average. For example, the aspect ratio of the wollastonite particulate according to some embodiments may be determined by first depositing a slurry including a sample of the wollastonite particulate on a standard SEM stage and coating the slurry with platinum. Images of the slurry may thereafter be obtained, and the particle dimensions may be determined, for example, using a computer-based analysis, in which it is assumed that the thickness and width of the particles are equal. The aspect ratio may then be determined by averaging a number of calculations (e.g., fifty calculations) of individual particle length-to-width aspect ratios. Other methods of determining aspect ratios are contemplated.

In certain embodiments, the wollastonite particulate may have an aspect ratio of at least 2:1. For example, the wollastonite particulate may have an aspect ratio of at least 3:1, an aspect ratio of at least 4:1, an aspect ratio of at least 7:1, an aspect ratio of at least 12:1, an aspect ratio of at least 15:1, or an aspect ratio of at least 20:1.

In certain embodiments of the method, the wollastonite particulate may have a median plate thickness of less than or equal to about 2 microns, such as, for example, less than or equal to about 1 micron. According to some embodiments, the wollastonite may have a median plate thickness ranging from about 3 to about 60 microns, or from about 4 to about 50 microns, or from about 5 to about 40 microns, or from about 6 to about 30 microns, or from about 7 to about 20 microns, or from about 8 to about 15 microns, or from about 9 to about 12 microns.

In certain embodiments, the wollastonite is present in the antimicrobial composition in an amount of about 2.5% to about 37.5% by weight, or about 5.0% to about 35.0% by weight, or about 7.5% to about 32.5% by weight, or about 10.0% to about 30.0% by weight, or about 12.5% to about 27.5% by weight, or about 15.0% to about 25.0% by weight, or about 17.5% to about 22.5% by weight, or about 18.0% to about 20.0% by weight based on the weight of the composition.

An antimicrobial agent according to the present invention may have the effect of inhibiting growth, stopping growth and/or killing microorganisms. An antimicrobial agent according to the present invention may include synthetic biocides and synthetic fungicides. Microorganisms are, for example, selected from bacteria, archaea, fungi, protozoa, algae and/or viruses. In certain embodiments, when using the combination of the antimicrobial agent and wollastonite of the invention, the growth of the microorganism is reduced up to about 10%, up to about 20%, up to about 30%, up to about 40%, up to about 50%, up to about 60%, up to about 70%, up to about 80%, up to about 85%, up to about 90%, up to about 100% in comparison to an untreated sample.

Without wishing to be bound by theory, the antimicrobial booster activity of wollastonite may be associated with the increasing pH in compositions comprising wollastonite.

Synthetic biocides and synthetic fungicides are widely used to control microbial growth in a number of products such as paints and coatings. As used herein “synthetic” refers to the making and/or the breaking of covalent chemical bonds using chemical synthesis. Widely used synthetic biocides and synthetic fungicides include, but are not limited to: 1,2-benzisothiazol-3(2H)-one (BIT), mixture of 5-cloro-2-methyl-2H-isothiazol-3-one and 2-methyl-2H-isothiazol-3-one (OMIT/MIT), 4,5-dichloro-2-octyl-2H-isothiazol-3-one (DCOIT), 2-methyl-2H-isothiazol-3-one (MIT), 2-octyl-2H-isothiazol-3-one (OIT), dibromopropionamide (DBNPA), glutraldehyde, 3-iodo-2-propynyl butylcarbamate (IPBC), terbutryn, 2-methyl-1,2-benzothiazol-3(2H)-one (MBIT), benzamide, 2,2′-dithiobis(N-methyl) (DTBMA), tetramethylol-acetylendiurea (TMAD), ethyleneglycol bishemiformal (EDDM), 2-bromo-2-(bromomethyl)pentanedinitrile (DBDCB), permethrin, propiconazole (DMI), chlorocresol (POMC), bronopol, thiabendazole (TBZ), 3-(3,4-dichlorophenyl)-1,1-dimethylurea (DCMU; diuron), 2-Benzyl-4-chlorophenol (chlorofen), fenoxycarb, tebuconazole, isoproturon, cyproconazole, fludioxonil, azoxystrobin, Zn-pyrithion, arbendazim, thiamethaxam.

In certain embodiments the synthetic biocide and/or synthetic fungicide is present in the antimicrobial composition in an amount of at least 0.01% by weight, and up to about 0.1% by weight, or up to about 0.09% by weight, or up to about 0.08% by weight, or up to about 0.07% by weight, or up to about 0.06% by weight, or up to about 0.05% by weight, or up to about 0.04% by weight, or up to about 0.03% by weight, or up to about 0.02% by weight.

In certain embodiments the synthetic biocide and/or synthetic fungicide is present in the antimicrobial composition in an amount of at least about 0.005% by weight, or at least about 0.0025% by weight, or at least about 0.00015% by weight, or at least about 0.0001% by weight based on the total weight of the composition. In certain examples, the synthetic biocide or and synthetic fungicide may be present in an amount according to the following list: 1,2-benzisothiazol-3(2H)-one (BIT) in an amount up to 0.006%, mixture of 5-cloro-2-methyl-2H-isothiazol-3-one and 2-methyl-2H-isothiazol-3-one (OMIT/MIT) in an amount up to 0.00035%, 4,5-dichloro-2-octyl-2H-isothiazol-3-one (DCOIT) in an amount up to 0.01%, 2-methyl-2H-isothiazol-3-one (MIT) in an amount up to 0.01%, 2-octyl-2H-isothiazol-3-one (OIT) in an amount up to 0.005%, dibromopropionamide (DBNPA) in an amount up to 0.1%, glutraldehyde in an amount up to 0.01%, 3-iodo-2-propynyl butylcarbamate (IPBC) in an amount up to 0.1%, terbutryn in an amount up to 0.01%, 2-methyl-1,2-benzothiazol-3(2H)-one (MBIT) in an amount up to 0.01%, benzamide, 2,2′-dithiobis(N-methyl) (DTBMA) in an amount up to 0.1%, tetramethylol-acetylendiurea (TMAD) in an amount up to 0.1%, ethyleneglycol bishemiformal (EDDM) in an amount up to 0.1% based on the weight of the composition.

In certain embodiments, the antimicrobial composition may comprise a resin, a dispersing agent, a coalescent agent, a defoamer, a filler, an extender, a neutralising agent, and/or a thickener.

Suitable resins are polymer resins, oligomer resins and natural resins. The polymer resin may be suitable for forming a homopolymer or a copolymer. Suitable examples comprise polyacrylates, polyesters, polyamides, polyurethanes, polyimides, polyurea, polyethers, polysilicones, vinyl acetate ethylene (VAE), styrene acrylates, fatty acid esters, as well as amine, alcohol, acid, ketone, ester, fluorinated, and aromatic functionalized versions of these polymer resins and physical blends and copolymers of the same.

Suitable coalescent agents include, for example, hydrophilic glycol ethers, for example the Dowanol® range such as Dowanol® DPM and Dowanol® DPnB, hydrophobic glycol ethers, Texanol® and block copolymers

Suitable defoamers include, for example, blends of surfactants, tributyl phosphate, fatty polyoxyethylene esters plus fatty alcohols, fatty acid soaps, silicone emulsions and other silicone containing compositions, waxes and inorganic particulates in mineral oil, blends of emulsified hydrocarbons and other compounds sold commercially as defoamers. Suitable dispersants include polyacrylates, such as the Dispex® range, hydrophilic blockcopolymer, acrylic block copolymer and non-ionic surfactants.

Suitable filler or extender materials may comprise one or more of hydrous kaolin, calcined kaolin, aggregated kaolin, calcium carbonate (ground or precipitated), talc, gypsum or other known white particulate mineral or pigment material. Suitable neutralising agents may comprise ammonium hydroxide, sodium hydroxide and organoamines such as dimethylamine, trimethylamine and ethylamine.

In certain embodiments the antimicrobial compositions comprise a pigment, such as titanium dioxide and colourants.

The paints or coating composition may be aqueous based or non-aqueous based.

The antimicrobial composition according to the invention is suitable for application on a range of articles or substrates. Suitable substrates include wood, plastic, metal and textiles. Methods for coating the articles are known to the skilled person and include brushing, spraying and application with a roller.

In certain embodiments, the particulate mineral and/or composition may have one or more of the following effects:
antibacterial effect;
antifungal effect;
antialgae effect;
antibacterial boost effect;
antifungal boost effect;
antialgae boost effect;
reduction of the use of synthetic biocides and/or synthetic fungicides;
more environmentally friendly control of microbials;
retaining one or more properties of paints or coatings such as opacity, gloss hardness, scrub resistance, anti-cracking and QUV resistance.

For the avoidance of doubt, the present application is directed to subject-matter described in the following numbered paragraphs.
1. An antimicrobial composition comprising an antimicrobial agent and wollastonite as an antimicrobial agent booster.
2. The antimicrobial composition of numbered paragraph 1, wherein the wollastonite is untreated.
3. The antimicrobial composition of numbered paragraph 1 or numbered paragraph 2, wherein the wollastonite has a median particle size d₅₀ in the range of 5 to 120 microns.
4. The antimicrobial composition of numbered paragraph 1 or numbered paragraph 2, wherein the wollastonite has a median particle size d₅₀ in the range of 5 to 20 microns.
5. The antimicrobial composition of any preceding numbered paragraph, wherein the wollastonite has a BET surface area in the range of 0.2 and 5.0 m²/g.
6. The antimicrobial composition of any preceding numbered paragraph, wherein the wollastonite is present in an amount of between 2.5 and 37.5% by weight percent based on the weight of the composition.
7. The antimicrobial composition of any preceding numbered paragraph, wherein the wollastonite has a shape factor of 2:1 to 20:1.
8. The antimicrobial composition of any preceding numbered paragraph, wherein the antimicrobial agent inhibits growth, stops growth and/or kills microorganisms.
9. The antimicrobial composition of numbered paragraph 8, wherein the microorganisms are selected from bacteria, archaea, fungi, protozoa, algae and/or viruses.
10. The antimicrobial composition of numbered paragraph 8 or numbered paragraph 9, wherein the microorganisms are selected from bacteria, fungi and/or algae.
11. The antimicrobial composition of any preceding numbered paragraph, wherein the antimicrobial agent comprises a synthetic biocide.
12. The antimicrobial composition of any preceding numbered paragraph, wherein the antimicrobial agent comprises a synthetic fungicide.
13. The antimicrobial composition of any preceding numbered paragraph comprising a synthetic biocide and/or synthetic fungicide in an amount of up to 0.10% by weight based on the weight of the total composition, preferably between 0.001 and 0.1% by weight based on the weight of the total composition, for example between 0.001 and 0.02% by weight based on the weight of the total composition, for example between 0.001 and 0.01% by weight based on the weight of the total composition.
14. The antimicrobial composition of any preceding numbered paragraph further comprising one or more of a resin, a dispersing agent, a coalescent agent, a defoamer, a filler, an extender, a thickener and/or a neutralising agent.
15. The antimicrobial composition of any preceding numbered paragraph further comprising a pigment, such as titanium dioxide.
16. The antimicrobial composition of numbered paragraph 15, wherein the pigment is titanium dioxide.
17. The antimicrobial composition of any preceding numbered paragraph, comprising:
   0.001 to 0.1% of an antimicrobial agent; and
   2.5 to 37.5% of wollastonite as an antimicrobial agent booster, based on the total weight of the coating composition.
18. The antimicrobial composition of numbered paragraph 17, comprising between 0.001 and 0.02% of an antimicrobial agent based on the total weight of the coating composition.
19. The antimicrobial composition of numbered paragraph 17, comprising between 0.001 and 0.01% of an antimicrobial agent based on the total weight of the coating composition.
20. The antimicrobial composition according to any preceding numbered paragraph, further comprising talc.
21. The antimicrobial composition according to numbered paragraph 20, comprising between 2.5 to 37.5% of talc.
22. The antimicrobial composition according to any preceding numbered paragraph, wherein the composition has a pH below 10, preferably below 9.5.
23. The antimicrobial composition according to any preceding numbered paragraph, wherein the antimicrobial agent is chosen from the list of 1,2-benzisothiazol-3(2H)-one (BIT), the mixture of 5-cloro-2-methyl-2H-isothiazol-3-one and 2-methyl-2H-isothiazol-3-one (OMIT/MIT), 4,5-dichloro-2-octyl-2H-isothiazol-3-one (DCOIT), 2-methyl-2H-isothiazol-3-one (MIT), 2-octyl-2H-isothiazol-3-one (OIT), dibromopropionamide (DBNPA), glutraldehyde, 3-iodo-2-propynyl butylcarbamate (IPBC), terbutryn, 2-methyl-1,2-benzothiazol-3(2H)-one (MBIT), benzamide, 2,2′-dithiobis(N-methyl) (DTBMA), tetramethylol-acetylendiurea (TMAD), ethyleneglycol bishemiformal (EDDM), 2-bromo-2-(bromomethyl)pentanedinitrile (DBDCB), permethrin, propiconazole (DMI), chlorocresol (PCMC), bronopol, thiabendazole (TBZ), 3-(3,4-dichlorophenyl)-1,1-dimethylurea (DCMU; diuron), 2-Benzyl-4-chlorophenol (chlorofen), fenoxycarb, tebuconazole, isoproturon, cyproconazole, fludioxonil, azoxystrobin, Zn-pyrithion, arbendazim, and thiamethaxam.
24. A paint or coating composition comprising an antimicrobial composition according to any preceding numbered paragraph.
25. A paint or coating composition consisting of an antimicrobial composition according to any preceding numbered paragraph.
26. The paint or coating composition comprising an antimicrobial composition according to numbered paragraph 25, wherein synthetic biocide and/or synthetic fungicide is present in an amount up to 0.10% by weight based on the weight of the composition.
27. Use of the antimicrobial composition according to any numbered paragraph from 1 to 26 to prevent microbial growth in a liquid and/or on an object.
28. Use of wollastonite as an antimicrobial booster.
29. Use of a blend of talc and wollastonite as an antimicrobial booster.
30. Method of preventing microbial growth in a liquid and/or on an object by applying the composition of any one of numbered paragraph 1 to 26 to a liquid and/or an object.
31. An article treated with an antimicrobial composition of numbered paragraphs 1 to 26.

### EXAMPLES

In the following examples, Wollastonite 1 is a wollastonite with a median particle size d₅₀ of 8 μm (measured by laser Microtrac) and a surface area BET of 1.8 m²/g. Wollastonite 2 is a wollastonite with a median particle size d₅₀ of 9 μm (measured by laser Microtrac) and a surface area BET of 1.6 m²/g.

### Example 1: In-can Protection Against Bacteria, Yeast and Mould

A number of paint formulations were prepared according to Table 1. Formulations 3 and 4 comprise wollastonite according to the invention. Formulations 1 and 2 are comparative examples comprising the minerals calcium carbonate and talc, wherein formulation 1 comprises a typical amount of biocide and formulation 2 contains 9 times less biocide.

TABLE 1
Paint formulations

| | | % weight | | | |
|---|---|---|---|---|---|
| | | Formulation No. | | | |
| Material (supplier) | Description | 1 | 2 | 3 | 4 |
| pHlex ® 400 (Ashland) | pH neutralising agent | 0.1 | 0.1 | 0.1 | 0.1 |
| Natrosol ® 250 MBR (Ashland) | Hydroxyethyl cellulose thickener | 0.4 | 0.4 | 0.4 | 0.4 |
| Byk ® 154 (Byk) | Dispersing agent | 0.7 | 0.7 | 0.7 | 0.7 |
| Byk ® 037 (Byk) | Defoamer | 0.8 | 0.8 | 0.8 | 0.8 |
| Vinnapas ® EP3360 (Wacker) | Vinyl acetate-ethylene dispersion | 13.3 | 13.3 | 13.3 | 13.3 |
| Kronos ® 2360 (Kronos) | Titanium dioxide | 18 | 18 | 18 | 18 |
| Biocide/Fungicide | | | | | |
| CMIT/MIT | | 0.001 | 0 | 0 | 0 |
| MIT | | 0.0013 | 0.0013 | 0.0013 | 0.0013 |
| BIT | | 0.0213 | 0.0013 | 0.0013 | 0.0013 |
| Durcal 5 (Omya) | Calcium carbonate | 22.5 | 22.5 | — | 22.5 |
| Luzenac 00C (Imerys) | Talc | 22.5 | 22.5 | 22.5 | — |
| Wollastonite A | Wollastonite | — | — | 22.5 | 22.5 |
| Demineralized water | | 21.7 | 21.7 | 21.7 | 21.7 |
| Total | | 100.0 | 100.0 | 100.0 | 100.0 |

The formations of Table 1 were prepared by mixing hydroxyethyl cellulose thickener, pH neutralising agent, biocide, dispersing agent, 0.3% defoamer, titanium dioxide and calcium carbonate, talc and/or wollasonite and stirring at 10 m/s for 20 minutes. Subsequently, the vinyl acetate-ethylene and defoamer were added to the suspension under gentle stirring.

Properties, such as the viscosity, fineness of grind and optical properties of the formulations 1 to 4 are present in Table 2.

TABLE 2
Properties of formulations 1 to 4

| Formulation No. | | 1 | 2 | 3 | 4 |
|---|---|---|---|---|---|
| Syneresis at 28 days of storage at RT | | 2 mm | 2 mm | 1 mm | 1 mm |
| (supernatant in mm) | | | | | |
| pH | | 8.48 | 8.47 | 9.07 | 9.16 |
| Fineness of grind | | 20-30 μm | 20-30 μm | 30-40 μm | 30-40 μm |
| (Jauge north ISO 1524) | | | | | |
| Brookfield viscosity Day 1 | 1 rpm | 185386 | 178529 | 181848 | 144630 |
| [MPa · S] | 10 rpm | 22715 | 25113 | 26103 | 21187 |
| (Spindles: R6) | 100 rpm | 3216 | 3414 | 4025 | 3336 |
| Application at 150 μm | L | 96.85 | 96.83 | 96.45 | 97.04 |
| wet film thickness | A | 0.31 | 0.32 | 0.22 | 0.44 |
| | B | 2.49 | 2.44 | 1.69 | 2.9 |
| | Opacity (%) | 99.10 | 98.83 | 99.68 | 98.85 |
| | Gloss @ 60° | 2.7 | 2.7 | 2.7 | 2.5 |
| | Gloss @ 85° | 2.3 | 2.3 | 2 | 2.4 |

| | | | | |
|---|---|---|---|---|
| Dispersion | Good | Good | Good | Good |

### Sterility Control:

A test sample (0.1 g or 0.1 ml) was homogenised for 5 min in a Skandex 450 SK450 paint shaker and surface-plated in triplicate on each of the following culture media:
1) Tryptic Soy Agar (TSA) for bacterial counts (incubation: 5 days at 30° C.±2° C.)
2) Malt Extract+Chloramphenicol agar, selective medium for yeast and mould counts (incubation: 5 days at 23° C.±2° C.).
   After 5 days, the microbial counts (as expressed in “colony forming units” per gram or per millilitre of product (CFU/g or CFU/ml)) were determined visually. The results of the test are shown in Table 3.

As may be seen in Table 3, all samples performed well in the yeast and mould test, exhibiting a CFU/g of less than 10. In the test involving bacteria, formulation 3 according to the invention performed exceptionally well and also exhibited a CFU/g of less than 10. For formulation 4 according to the invention a CFU/g of 26 was observed, which is an improvement over the comparative example according to formulation 2. This test demonstrates the formulations according to the invention are active against bacteria, yeast and mould and that wollastonite allows to obtain excellent results with a very low amount of biocide; i.e. wollastonite is surprisingly an antimicrobial agent booster. It has to be noted that the combination of the two minerals wollastonite and talc shows an even improved antimicrobial agent booster effect.

TABLE 3
Results of sterility test¹

| Formula No. | Bacteria (CFU/g) | Yeast/Mould (CFU/g) |
|---|---|---|
| 1 | 23 | <10 |
| 2 | 27 | <10 |
| 3 | <10 | <10 |
| 4 | 26 | <10 |

¹This test method allows the detection of microbial contamination as low as 10 CFU/g or 10 CFU/ml (detection limit). A contamination lower than 10 CFU/g or 10 CFU/ml cannot be detected.

### In-Can Challenge Test

A test sample of 50 g of each of the formulation 1 to 4 of Table 1 were stored at 23° C. C±2° C. for the duration of the challenge test. 4 inoculations were performed once a week over 5 weeks. The samples were inoculated with the inoculum composition shown in Table 4 and after 5 days the amount of bacteria, yeast and mould was determined. This inoculation and evaluation steps were repeated four times. The results of these experiments are shown in Table 5.

To assess contamination following each inoculation, 0.1 ml of sample was surface plated in triplicate on:
1) Tryptic Soy Agar (TSA) for bacterial counts (incubation: 5 days at 30° C.±2° C.),
2) Malt Extract+Chloramphenicol agar, selective medium for yeast and mould counts (incubation: 5 days at 23° C.±2° C.).
   After 5 days, the microbial counts (as expressed in “colony forming units” per gram or per millilitre of product (CFU/g or CFU/ml)) were determined visually. The results of the test are shown in Table 5.

TABLE 4
Inoculum composition

| Microorganism | Reference |
|---|---|
| Bacteria | |
| Alcaligenes faecalis | DSM 30030 |
| Burkholderia cepacia | ATCC 25416 |
| Enterobacter aerogenes | ATCC 13048 |
| Proteus hauseri | DSM 30118 |
| Pseudomonas aeruginosa | DSM 939 |
| Pseudomas fluorescens | DSM 50090 |
| Pseudomonas putida | DSM 291 |
| Yeast | |
| Candida lipolytica | DSM 8218 |
| Saccharomyces cerevisiae | ATCC 2601 |
| Mould | |
| Aspergillus brasiliensis | ATCC 16404 |
| Penicillium ochrochloron | DSM 1945 |

Inoculum concentration bacteria ≈ 10⁸ CFU/ml; yeast & mould ≈ 10⁶ CFU/ml

TABLE 5
In-can challenge results¹

| | Inoculations | | | |
|---|---|---|---|---|
| Formulation No. | 1 | 2 | 3 | 4 |
| 1 | 1B | 0 | 1B | 0 |
| 2 | 3Y | 3Y | 3Y 1M | 3Y |
| 3 | 0 | 0 | 0 | 0 |
| 4 | 1B | 1B | 1BM | 1BM |

1B = Bacteria; Y = Yeast; M = Mould
3 ≥ 1000 CFU/g or /ml = Inefficient protection against microbial contamination
2 ≥ 100-999 CFU/g or /ml = Moderate protection against microbial contamination
1 ≥ 10-99 CFU/g or /ml = Optimal protection against microbial contamination
0 ≥ 0-9 CFU/g or /ml = Optimal protection against microbial contamination

As may be seen from the result in Table 5, the formulations 3 and 4 according to the invention demonstrate an optimal protection against microbial contamination over four inoculation cycles. Formulation 3 in particular demonstrated an extremely low microbial contamination of between 0 and 9 CFU/g for each type of contaminant, i.e. bacteria, yeast or mould. Formulation 4 also performed very well, exhibiting no yeast and no mould for the first and second inoculation and only a bacterial concentration represented by “1”, which in absolute terms represents 16 CFU/g and 13 CFU/g, respectively. After the third and fourth inoculations the bacteria remained categorised as “1” with the absolute amount of bacteria being 36 CFU/g and 16 CFU/g, respectively. In addition, mould was also present during inoculation 3 and 4, falling into category “1”, with an absolute amount of mould being 16 CFU/g and 13 CFU/g, respectively.

The results obtained for the formulations 3 and 4 according to the invention were a marked improvement on the comparative example formulation 2, which contained only a low amount of synthetic biocide or synthetic fungicide and no wollastonite. The results for formulation 3 were also an improvement on the comparative example formulation 1, which comprises a typical amount of synthetic biocide. Formulation 4 was also comparable to comparative formulation 1, especially at the first inoculation cycle. This demonstrates that the environmentally unfriendly and more toxic synthetic biocides may be partly replaced by wollastonite in in-can formulations, whilst exhibiting the same good antimicrobial properties.

### Example 2

Other paint formulations were prepared according to Table 6. Formulations 7 and 8 comprise wollastonite 1. Formulations 5 and 6 are comparative examples comprising biocide, the minerals calcium carbonate and talc, wherein formulation 5 comprises a typical amount of biocide and formulation 6 contains 80 times less biocide. Formulation 7 comprises 80 times less biocide whereas formulation 8 comprises 9 times less biocide than the comparative formulation 5.

TABLE 6

| | % weight | | | |
|---|---|---|---|---|
| | Formulation No. | | | |
| Material | 5 | 6 | 7 | 8 |
| Tap water | 39.42 | 39.66 | 38.92 | 38.89 |
| Natrosol 250 | 0.70 | 0.70 | 0.70 | 0.70 |
| HBR | | | | |
| Phlex 400 | 0.10 | 0.10 | 0.10 | 0.10 |
| Byk 199 | 0.25 | 0.25 | 0.25 | 0.25 |
| Ecodis P90 | 0.40 | 0.40 | 0.40 | 0.40 |
| BYK 1615 | 0.50 | 0.50 | 0.50 | 0.50 |
| Biocide/ | | | | |
| Fungicide | | | | |
| MIT | 0.010 | 0.001 | 0.001 | 0.006 |
| BIT | 0.010 | 0.001 | 0.001 | 0.006 |
| DCOIT | 0.150 | 0.000 | 0.000 | 0.010 |
| IPBC | 0.070 | 0.000 | 0.000 | 0.005 |
| CMIT/MIT | 0.00027 | 0.00025 | 0.00028 | 0.00028 |
| Chronos 2190 | 10.00 | 10.00 | 10.00 | 10.00 |
| Imercarb 3L | 28.89 | 28.89 | 17.37 | 17.37 |
| Wollastonite 1 | | | 10.00 | 10.00 |
| Acronal S790 | 18.75 | 18.75 | 21.01 | 21.01 |
| Texanol | 0.75 | 0.75 | 0.75 | 0.75 |
| TOTAL, gram | 100.00 | 100.00 | 100.00 | 100.00 |
| PVC/CPVC ratio | 0.92 | 0.92 | 0.92 | 0.92 |
| Solids by | 30.80 | 30.80 | 30.80 | 30.80 |
| Volume, % | | | | |
| Density, g/ml | 1.37 | 1.36 | 1.35 | 1.35 |

Sterility and in-can properties are assessed the same way as it is described in example

As seen in Table 7, this test demonstrates that the formulations according to the invention are active against bacteria, yeast and mould and that wollastonite allows to obtain excellent results with a very low amount of biocide; i.e. wollastonite is surprisingly an antimicrobial agent booster.

TABLE 7
Sterility results

| Formula No. | Bacteria (CFU/g) | Yeast/Mould (CFU/g) |
|---|---|---|
| 5 | <10 | <10 |
| 6 | 13 | <10 |
| 7 | 10 | <10 |
| 8 | <10 | <10 |

As may be seen from the result in Table 8, the formulation 8 according to the invention demonstrates an optimal protection against microbial contamination over four inoculation cycles. In particular it demonstrates an extremely low microbial contamination for each type of contaminant, i.e. bacteria, yeast or mould. Formulation 7 also performed very well, exhibiting no bacteria, no yeast and no mould for the first and second inoculation and only for the third inoculation a yeast concentration represented by “1”, which in absolute terms represents 16 CFU/g and 13 CFU/g.

The results obtained for the formulations 7 and 8 according to the invention were a marked improvement on the comparative example formulation 6, which contained a low amount of biocide but no wollastonite. The results for formulation 8 were also an improvement on the comparative example formulation 5, which comprises a typical amount of synthetic biocide, because it allows to obtain the same excellent results while using only a very low amount of synthetic biocides. This demonstrates that the environmentally unfriendly and more toxic synthetic biocides may be partly replaced by wollastonite in in-can formulations, whilst exhibiting the same good antimicrobial properties.

TABLE 8
In-Can results

| | Inoculations | | | |
|---|---|---|---|---|
| Formulation No | 1 | 2 | 3 | 4 |
| 5 | 0 | 0 | 0 | 0 |
| 6 | 0 | 1Y | 3Y | 3Y |
| 7 | 0 | 0 | 1Y | 1B2Y |
| 8 | 0 | 0 | 0 | 0 |

### Example 3: Paint Film Protection Against Fungi (Mould and Yeast)

The formulations 9, 10 and 11 according to Table 9 were used to test paint film protection against fungi (mould and year) according to the procedure NFX 41520 (Essai B).

TABLE 9
Formulations for film tests

| | % weight | | |
|---|---|---|---|
| | Formulation No. | | |
| Material | 9 | 10 | 11 |
| Kronos 2190-titanium | 10 | 10 | 10 |
| dioxide | | | |
| Imercarb ® 3L-calcium | 28.9 | 28.9 | 2.9 |
| carbonate | | | |
| Wollastonite 2 | 0 | 0 | 22.5 |
| Acronal ® S790 | 18.8 | 18.8 | 23.8 |
| Texanol ®-coalescent | 0.8 | 0.8 | 0.8 |
| agent | | | |
| Tap water | 39.3 | 39.5 | 38.0 |
| Natrosol 250 HBR-additive | 0.7 | 0.7 | 0.7 |
| Phlex 400-additive | 0.1 | 0.1 | 0.1 |
| Byk 199-additive | 0 | 0 | 0.3 |
| Ecodis P90-additive | 0.7 | 0.7 | 0.4 |
| BYK 1615-additive | 0.5 | 0.5 | 0.5 |
| Biocide/Fungicide | | | |
| MIT | 0.01 | 0.001 | 0.006 |
| BIT | 0.01 | 0.001 | 0.006 |
| DCOIT | 0.15 | 0 | 0.01 |
| IPBC | 0.07 | 0 | 0.005 |
| CMIT/MIT | 0.00027 | 0.00025 | 0.00032 |
| TOTAL, gram | 100.00 | 100.00 | 100.00 |

To obtain paint films with a dry thickness of about 100 μm, formulations 9, 10 and 11, about ±330 μm of wet paint were applied on glass fibre tissue and dried for 5 weeks at room temperature. The paint film on the glass fibre tissue was then placed in petri dishes (3 replications in separate petri dishes for each sample) containing nutrients for fungi. An inoculum of 9 species (Alternaria alternate, Trichoderma viride, Cladosporium herbarum, Aureobasidium pullalans, Chaetomium globosum, Aspergillus niger, Penicillium funiculosum, Paecilomyces varotii and Stachybotrys atra) was added to the nutrient (1 ml) and to the paint film (1 ml). The petri dishes were then placed under a controlled relative humidity of 95%±1% and at a temperature of 30° C.±1% for 4 weeks. The samples were then inspected visually and assigned a score as follows:

0=no development of fungi visible by eye;

1=limited development of fungi (dispersed over the surface);

2=fungi development <25% of the surface;

3=fungi development 25 to 50% of the surface;

4=fungi development >50% of the surface;

5=fungi development at 100% of the surface.

TABLE 10
Results of paint film
protection test against fungi (mould and yeast)

| | Visual score of paint film | | | Average |
|---|---|---|---|---|
| Formulation No. | A | B | C | visual score |
| 9 | 0 | 0 | 0 | 0 |
| 10 | 4 | 2 | 3 | 3 |
| 11 | 2 | 2 | 3 | 2.3 |

As shown in FIG. 1 and Table 10, formulation 11 (FIG. 1c)) according to the invention provides an improved fungi resistance over paint films with the same low amount of synthetic biocide and synthetic fungicide, i.e. formulation 10 (FIG. 1b)). Formulation 9 (FIG. 1a)) demonstrated the best antifungal activity, but formulation 9 comprises very high amounts of synthetic biocide and synthetic fungicide, namely 1.3% by weight based on the weight of the composition. This high amount of synthetic biocide and synthetic fungicide renders this comparative example of formulation 9 undesirable due to their skin irritation properties and toxicity. The results show that the undesirable synthetic biocide and synthetic fungicide can be partly replaced with wollastonite to provide formulations with antifungal properties.

### Example 4: Paint Film Protection Against Algae

The formulations 9, 10 and 11 according to Table 9 were also used to test paint film protection against algae.

To obtain paint films with a dry thickness of about 100 μm, formulations 9, 10 and 11, about ±330 μm of wet paint were applied to cement fibre plates (10 cm×20 cm) and dried for 2 months. The paint film was then placed in an aquarium simulated with day and night conditions with daylight illumination for 12 hours a day, a temperature of 28 to 30° C., a relative humidity of 85 to 100%. Once a day the paint film was sprayed with inoculum medium for 1 hour. The inoculum medium comprised Stichococcus bacillaris, Nostoc commune and Scenedesmus vacuolatus in a 1 litre aqueous solution comprising sodium nitrate (1 g/L), magnesium sulfate (0.513 g/L), dipotassium phosphate (0.187 g/L), disodium phosphate (0.063 g/L), calcium chloride (0.058 g/L), ammonium chloride (0.05 g/L), and ferric chloride (0.003 g/L). The samples were monitored for 11 weeks and inspected visually and assigned a score as follows.

0=no development of algae visible by eye;

1=limited development of algae (dispersed over the surface);

2=algae development <10% of the surface;

3=algae development <25% of the surface;

4=algae development <50% of the surface;

5=algae development >50% of the surface.

TABLE 11
Results of paint film protection test against algae

| | Visual score of Formulation No. | | |
|---|---|---|---|
| Week number | 9 | 10 | 11 |
| 1 | 0 | 1 | 1 |
| 2 | 0 | 1 | 0 |
| 3 | 0 | 2 | 1 |
| 4 | 0 | 2 | 1 |
| 5 | 0 | 3 | 1 |
| 6 | 0 | 4 | 1 |
| 7 | 1 | 4 | 2 |
| 9 | 1 | 5 | 2 |
| 10 | 1 | 5 | 2 |
| 11 | 1 | 5 | 2 |

As shown in FIG. 2 and Table 11, formulation 11 (FIG. 2c)) according to the invention provides an improved algae resistance over paint films with only a low amount of synthetic biocide and synthetic fungicide, i.e. formulation 10 (FIG. 2b)). Formulation 9 (FIG. 2a)) demonstrated the best antialgae activity, but as discussed above formulation 9 comprises very high amounts of synthetic biocide and synthetic fungicide, namely 1.3% by weight based on the weight of the composition. The results for formula 11 (comprising wollastonite) are also much closer to those obtained for formula 9 (comprising typical amounts of synthetic biocide/synthetic fungicide) than for formula 10 (comprising a low amount of synthetic biocide/synthetic fungicide). The results show that wollastonite is also a good booster for the antialgae effect, demonstrating good results even in the presence of low amounts of undesirable synthetic biocides and synthetic fungicides. Therefore, it has been demonstrated that wollastonite can partly replace synthetic biocides and synthetic fungicides to provide formulations with antialgae properties.

1. An antimicrobial composition comprising an antimicrobial agent and wollastonite as an antimicrobial agent booster.

2. The antimicrobial composition of claim 1, wherein the wollastonite is untreated.

3. The antimicrobial composition of claim 1, wherein the wollastonite has a median particle size d₅₀ in the range of 5 to 120 microns and/or wherein the wollastonite has a BET surface area in the range of 0.2 and 5.0 m²/g.

4. The antimicrobial composition of claim 1, wherein the wollastonite is present in an amount of between 2.5 and 37.5% by weight percent based on the weight of the composition.

5. The antimicrobial composition of claim 1, wherein the antimicrobial agent inhibits growth, stops growth and/or kills microorganisms.

6. The antimicrobial composition of claim 5, wherein the microorganisms are selected from bacteria, archaea, fungi, protozoa, algae and viruses.

7. The antimicrobial composition of claim 1, wherein the antimicrobial agent comprises a synthetic biocide and/or a synthetic fungicide.

8. The antimicrobial composition of claim 1, further comprising a synthetic biocide and/or synthetic fungicide in an amount of up to 0.10% by weight based on the weight of the total composition.

9. The antimicrobial composition of claim 1, further comprising one or more of a resin, a dispersing agent, a coalescent agent, a defoamer, a filler, an extender, a thickener and/or a neutralising agent.

10. The antimicrobial composition of claim 1, further comprising a pigment, such as titanium dioxide.

11. The antimicrobial composition of claim 1, further comprising:
0.001 to 0.01% of an antimicrobial agent, based on the total weight of the coating composition; and
2.5 to 37.5% of wollastonite as an antimicrobial agent booster, based on the total weight of the coating composition.

12. The antimicrobial composition according to claim 11, further comprising talc.

13. The antimicrobial composition according to claim 12, comprising between 2.5 to 37.5% of talc.

14. The antimicrobial composition according to claim 11, wherein the composition has a pH below 10.

15. The antimicrobial composition according claim 11, wherein the antimicrobial agent is chosen from the list of 1,2-benzisothiazol-3(2H)-one (BIT), the mixture of 5-cloro-2-methyl-2H-isothiazol-3-one and 2-methyl-2H-isothiazol-3-one (CMIT/MIT), 4,5-dichloro-2-octyl-2H-isothiazol-3-one (DCOIT), 2-methyl-2H-isothiazol-3-one (MIT), 2-octyl-2H-isothiazol-3-one (OIT), dibromopropionamide (DBNPA), glutraldehyde, 3-iodo-2-propynyl butylcarbamate (IPBC), terbutryn, 2-methyl-1,2-benzothiazol-3(2H)-one (MBIT), benzamide, 2,2′-dithiobis(N-methyl) (DTBMA), tetramethylol-acetylendiurea (TMAD), ethyleneglycol bishemiformal (EDDM), 2-bromo-2-(bromomethyl)pentanedinitrile (DBDCB), permethrin, propiconazole (DMI), chlorocresol (PCMC), bronopol, thiabendazole (TBZ), 3-(3,4-dichlorophenyl)-1,1-dimethylurea (DCMU; diuron), 2-Benzyl-4-chlorophenol (chlorofen), fenoxycarb, tebuconazole, isoproturon, cyproconazole, fludioxonil, azoxystrobin, Zn-pyrithion, arbendazim, and thiamethaxam.

16. A paint or coating composition comprising of an antimicrobial composition according to claim 1.

17. A paint or coating composition consisting of an antimicrobial composition according to claim 1.

18. The paint or coating composition comprising an antimicrobial composition according to claim 16, wherein synthetic biocide and/or synthetic fungicide is present in an amount up to 0.10% by weight based on the weight of the composition.

19. (canceled)

20. (canceled)

21. (canceled)

22. A method of preventing microbial growth in a liquid and/or on an object, the method comprising applying the composition of claim 1 to a liquid and/or an object.

23. An article treated with an antimicrobial composition according to claim 1.
